(19) United States
(12) Patent Application Publication
(10) Pub. No.: US 2008/0178481 A1
(43) Pub. Date: Jul. 31, 2008

(54) Rod-adjusting Structure for a Rod Type Linear Motor

(76) Inventor: Chi-Tai Liu, Taichung Industrial Park (TW)

Correspondence Address: Dr. BANGER SHIA, 102 Lindencrest Ct., Sugar Land, TX, 77479-5201, US

(21) Appl. No.: 11/627,969

(22) Filed: Jan. 28, 2007

(51) Int. Cl. G01B 7/30

(52) U.S. Cl. 33/1 PT

(57) ABSTRACT

A rod-adjusting structure for a rod type linear motor, at least one end or end surface of the rod is provided with a scale, and a body of the linear motor is formed with an index located correspondingly to the scale of the rod. When assembling the rod, the index can be pointed to one of the reticles of the scale to serve as an assembly reference. After a period of use, if the rod is deviated, such arrangements can adjust the rod to return to the origin position.

### BACKGROUND OF THE INVENTION

1. Field of the Invention

The present invention relates to a rod-adjusting structure for a rod type linear motor, and more particularly to a rod-adjusting structure for a rod type linear motor which is provided with a scale at an end or end surface of the rod and is formed with an index located correspondingly to the scale for positioning and adjusting the rod of the linear motor.

2. Description of the Prior Art

Referring to FIG. 1, a conventional rod type linear motor 1 comprises a rod 11 transversely mounted on a body 10, and a mover 12 is inserted on the rod 11 for supporting various tools or work pieces and is moved along the rod 11. The rod 11 is a stator of a linear motor, a magnetic element (such as a permanent magnet) disposed in the rod 11 cooperates with coils disposed in the mover 12 to form a magnetic field, so as to drive the mover 12 to move on the rod 11 smoothly.

The conventional rod type linear motor is simplified in structure and can be positioned precisely, and when using in a processing machine, the processing machine can obtain better processing precision. Thereby, such a rod type linear motor has been widely used in different fields in recent years, and particularly in the precise manufacturing and processing fields, further, the processing machine using such a linear motor has become a trend for the manufacturers.

However, the conventional rod type linear motor still has some disadvantages needed to be improved, for example: the rod 11 (the stator) and the mover 12 of the rod type linear motor must be disposed on the body 10 precisely, otherwise the mover 12 cannot move along the rod 11 smoothly during the processing. Since there is no relative structure between the conventional column-shaped rod 11 and the body 10, the rod 11 cannot be positioned precisely.

Especially for a longer rod type linear motor, since the mover 12 is moved on the relatively long rod 11, after a period of use, the rod 11 will be deviated relative to the body 20 by the influence of the gravity and the moving force, and this change is unperceivable with naked eyes. Thereby, the rod 11 must be adjusted regularly to solve the problem caused by the deviation of the rod 11. Further, since there is no relative structure between the conventional column-shaped rod 11 and the body 10, the rod 11 is hard to position.

The present invention has arisen to mitigate and/or obviate the afore-described disadvantages.

### SUMMARY OF THE INVENTION

The primary objective of the present invention is to provide a rod-adjusting structure for a rod type linear motor which is provided with a scale at an end or end surface of the rod, and a body is formed with an index located correspondingly to the scale for positioning and adjusting the rod.

To achieve the object of the present invention, an end or end surface of a rod is provided with a scale, and on a suitable position of a body is formed an index located correspondingly to the scale, so as to position the rod precisely.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a perspective view of a conventional rod type linear motor;

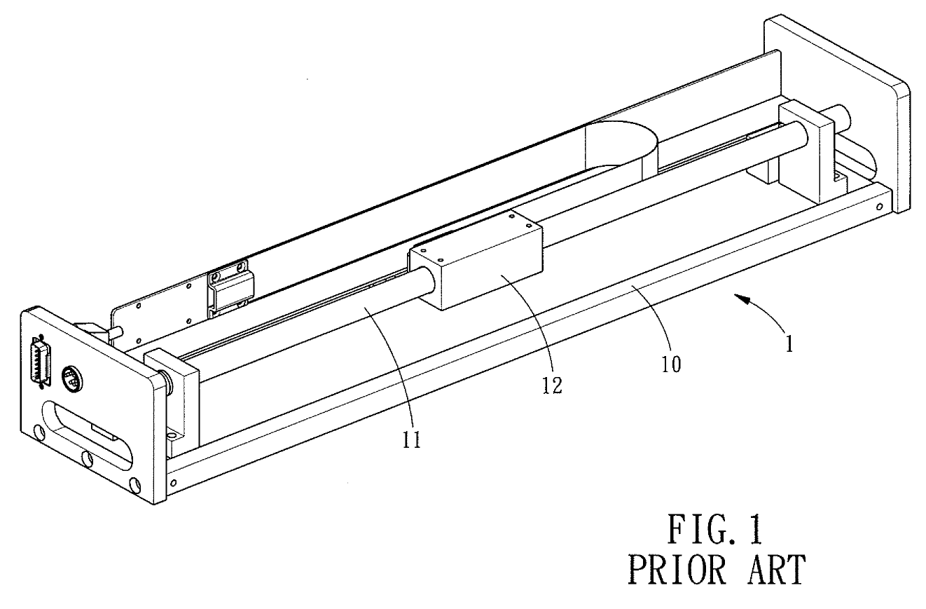

FIG. 2 is a perspective view of a rod and a mover in accordance with a rod-adjusting structure for a rod type linear motor of the present invention;

FIG. 3 is a perspective view of the rod-adjusting structure for a rod type linear motor in accordance with the present invention; and

FIG. 4 is an illustrative view in accordance with the present invention of showing the rod and the index.

### DETAILED DESCRIPTION OF THE PREFERRED EMBODIMENTS

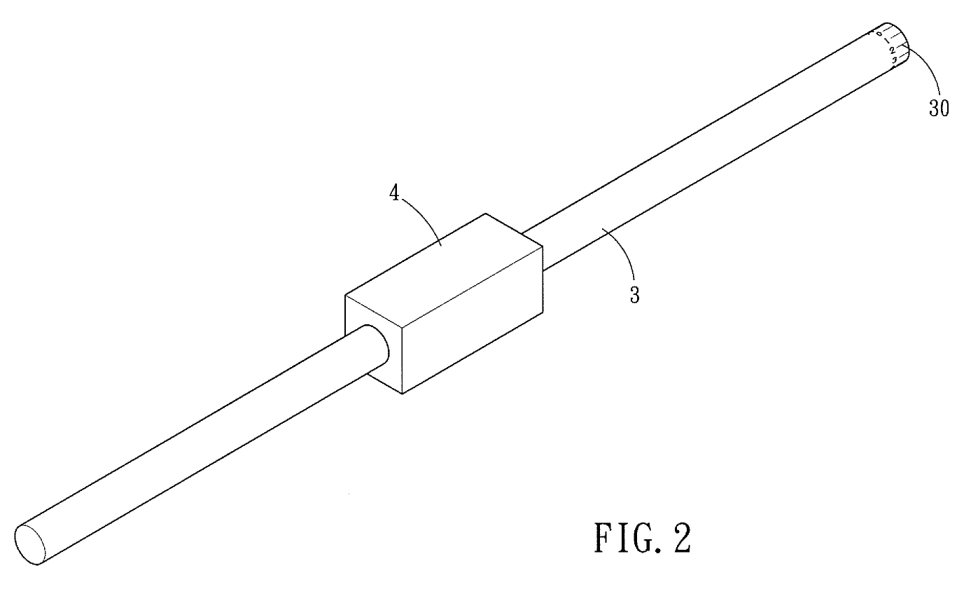

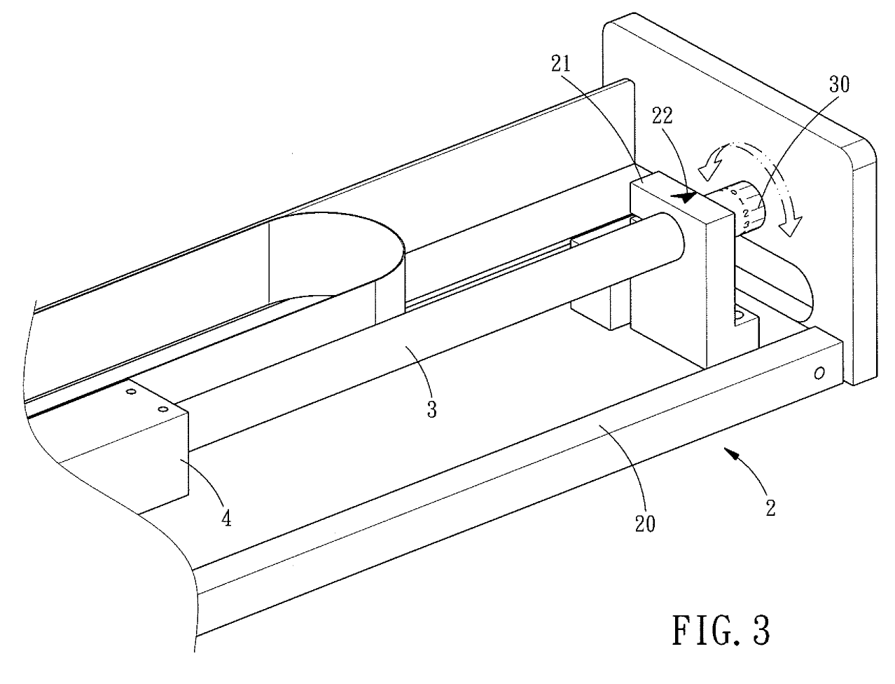

Referring to FIGS. 2 and 3, a rod-adjusting structure for a rod type linear motor in accordance with the present invention comprises a rod 3 disposed on a body 20 of a rod type linear motor 2. The rod 3 is a stator of the motor and is disposed with magnetic elements, and both ends of the body 20 are disposed with a supporting seat 21 for insertion of the rod 3. A mover 4 is inserted on the rod 3 and is interiorly disposed with coils for cooperating with the magnetic elements of the rod 3 to produce a magnetic field, such that the mover 4 can be moved on the rod 3 smoothly by the magnetic field effects, and the present invention is characterized in that:

At least one end of the rod 3 is provided with a scale 30, the reticles and numbers of the scale 30 are arranged equidistantly (as shown in the present embodiment) for easy visual identification, or the scale 30 can be shown by a single reticle or an index or other indications. On the supporting seat 21 of the body 20 is formed an index 22 located correspondingly to the scale 30 of the rod 3, and the index 22 can be an arrow or a reticle or other indications. When assembling the rod 3, the index 22 can be pointed to one of the reticles of the scale 30 to serve as an assembly reference.

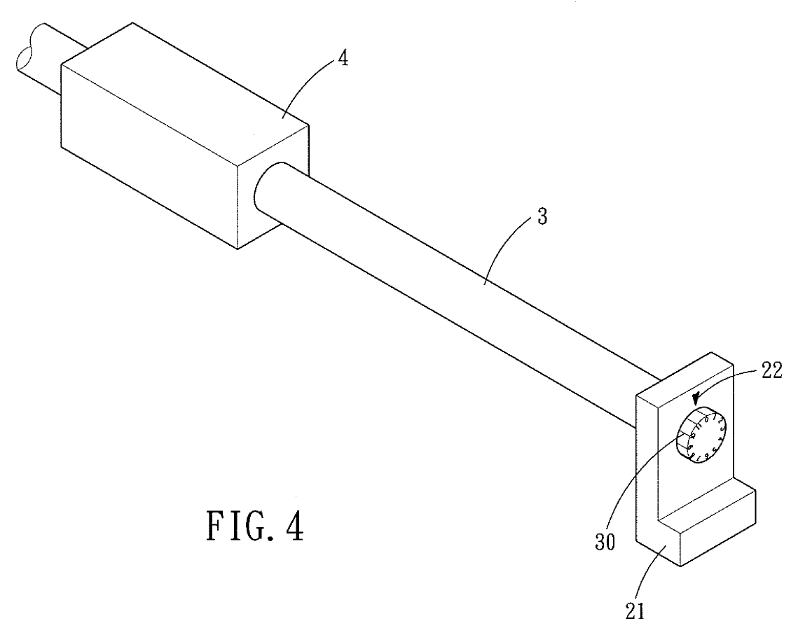

Referring to FIG. 4, the scale 30 of the rod 3 also can be disposed on an end surface of the rod 3, and the index 22 is formed on the supporting seat 21 and is located correspondingly to the position of the scale 30 for easy visual identification. The arrangements of the scale 30 of the rod 3 and the index 22 enable the rod 3 to be fixed to the body 20 easily, in particular, after a period of use, such arrangements can check whether the rod 3 is deviated or not. Moreover if the rod 3 is deviated, the rod 3 can be easily adjusted to return to the origin position.

To summarize, the arrangements of the scale and index of the rod and the body enables the rod to be positioned and adjusted easily.

While we have shown and described various embodiments in accordance with the present invention, it should be clear to those skilled in the art that further embodiments may be made without departing from the scope of the present invention.

What is claimed is:

1. A rod-adjusting structure for a rod type linear motor, comprising:
a rod disposed on a body of a rod type linear motor;
a mover inserted on the rod and moved along the rod, characterized in that:
at least one end or end surface of the rod is provided with a scale;
the body is formed with an index located correspondingly to the scale of the rod, when assembling the rod, the index is pointed to one of reticles of the scale to serve as an assembly reference.

2. The rod-adjusting structure for a rod type linear motor as claimed in claim 1, wherein the scale is reticles or numbers or reticles and numbers arranged equidistantly.

3. The rod-adjusting structure for a rod type linear motor as claimed in claim 1, wherein the scale is a single reticle or an index.

4. The rod-adjusting structure for a rod type linear motor as claimed in claim 1, wherein the index of the body is an arrow.

5. The rod-adjusting structure for a rod type linear motor as claimed in claim 1, wherein the index of the body is shown by a scale or reticles.

6. The rod-adjusting structure for a rod type linear motor as claimed in claim 1, wherein both ends of the body are disposed with a supporting seat for insertion of the rod, and the index is formed on the supporting seat located correspondingly to the scale of the rod.

7. The rod-adjusting structure for a rod type linear motor as claimed in claim 1, wherein both ends or end surfaces of the rod are provided with the scale, and both ends of the body are formed with an index located correspondingly to the scale of the rod.

8. The rod-adjusting structure for a rod type linear motor as claimed in claim 2, wherein both ends or end surfaces of the rod are provided with the scale, and both ends of the body are formed with an index located correspondingly to the scale of the rod.

9. The rod-adjusting structure for a rod type linear motor as claimed in claim 3, wherein both ends or end surfaces of the rod are provided with the scale, and both ends of the body are formed with an index located correspondingly to the scale of the rod.
